(19) United States
(12) Patent Application Publication
(10) Pub. No.: US 2018/0243776 A1
(43) Pub. Date: Aug. 30, 2018

(54) INTELLIGENT FLEXIBLE HUB PAINT SPRAYING LINE AND PROCESS

(71) Applicant: CITIC Dicastal CO., LTD., Qinhuangdao (CN)

(72) Inventors: Zhiwei QIN, Qinhuangdao (CN); Huanming MA, Qinhuangdao (CN); Bo NING, Qinhuangdao (CN); Hongtao WANG, Qinhuangdao (CN); Zaide WANG, Qinhuangdao (CN); Zhiliang ZHANG, Qinhuangdao (CN); Yongwang ZHAO, Qinhuangdao (CN)

(21) Appl. No.: 15/594,545

(22) Filed: May 12, 2017

(30) Foreign Application Priority Data
Feb. 25, 2017 (CN) 201710105130.5

(51) Int. Cl. B05B 13/02; B05B 13/04; B05B 15/12; B05C 9/14; B05D 1/02

(52) U.S. Cl. CPC B05B 13/0235; B05B 13/0457; B05D 1/02; B05B 15/1288; B05C 9/14; B05B 15/1207

(57) ABSTRACT

The present disclosure provides an example intelligent flexible hub paint spraying line and process. The equipment comprises a control system, a conveying chain, an on-line area, a wheel type recognition system, a brace recognition system, a spray area, a paint spraying system, a transfer area, an oven, an off-line area and accessory equipment. By combining the multi-color paint spraying system with intelligent recognition, the paint spraying line realizes simultaneous on-line spraying of multiple colored paint hubs, avoids decline of equipment efficiency due to replacement of the paint, avoids classified temporary stacking of hubs to be sprayed in the previous procedure and excessive in-process, breaks through the traditional batch spraying mode, and adapts to current market demands for progressive small batch and customization.

### RELATED APPLICATION

This application claims priority to Chinese Patent Application No. 201710105130.5, filed on Feb. 25, 2017, which is hereby incorporated by reference in its entirety.

### TECHNICAL FIELD

The present disclosure relates to an intelligent flexible hub paint spraying line and process, and relates to the field of hub spraying technology.

### BACKGROUND

At present, automobile hub products, surface coatings of which are differentiated and batches of which are small, are increased day by day; when a common automatic coating line is used for spraying different paints, empty switching is needed and the spray gun needs to be cleaned, so that the production time is delayed, paints are easily polluted, and more rejects of high appearance requirement products are caused; and in order to solve the above problems, hubs to be sprayed often need to be stacked by category according to the shapes of the hubs and the spraying processes, and then are concentrated on line, i.e., are produced in batch, inevitably resulting in massive in-process. Under current market demands for progressive small batch and customization, the traditional spraying mode already cannot meet the market demands, so a production mode and equipment capable of realizing flexible spraying are urgently needed.

### SUMMARY

Aiming at the above shortcomings of the prior art, the present disclosure provides an intelligent flexible hub paint spraying line and process, which can realize continuous online of hubs to be sprayed in different shapes and multiple spraying processes, and avoid frequent switching of coatings, classified temporary stacking and excessive in-process.

The technical solution for solving the technical problems adopted in the present disclosure is that a flexible intelligent hub paint spraying line includes a control system, a wheel type recognition system, a brace recognition system, a conveying chain, an on-line area, a spray area, a paint spraying system, a transfer area, an oven, an off-line area and accessory equipment. A plurality of spray rooms are serially arranged in the spray area, a plurality of spray stations are arranged in each spray room, and a rotating station and a spraying robot are arranged at each spray station; the paint spraying system includes a spraying manipulator and a multi-color paint supply system; the wheel type recognition system is arranged in front of the inlet of the spray area and connected with the control system through weak current; the conveying chain includes a chain, braces and a driving mechanism, a read-write tag is arranged below each brace, the brace recognition system includes the read-write tags as well as tag read-write devices arranged at the wheel type recognition system and the inlets of the spray rooms, and the tag read-write devices are connected with the control system by adopting weak current.

Further, preferably, the wheel type recognition system adopts a visual recognition system, and performs recognition input on all wheel type image information before production and edits wheel type code information corresponding to images one by one.

Further, the wheel type recognition system may adopt a two-dimensional code recognition system, and comprises a two-dimensional code marked at the selected part of the inner cavity of each hub, and includes a two-dimensional code scan gun arranged at the bottom.

Further, the read-write tag may adopt a radio frequency identification tag, and the corresponding read-write device is a radio frequency identification reader-writer.

Further, the read-write tag may adopt a two-dimensional code tag, and the corresponding read-write device is a dedicated scan reader-writer.

A flexible intelligent hub paint spraying process specifically includes the steps of feeding a hub to be sprayed, recognizing the model of the hub, recognizing the brace, storing wheel type information, feeding the hub into the spray area, reading the brace, selecting a spray room and a spray station, calling spray parameters, spraying, completing spraying, leaving the spray room, transferring, baking and curing, and discharging the product.

Storing wheel type information means that, after the recognition system recognizes the model of the hub, successfully matched hub characteristic information is stored in a database of the control system according to the tag code of the corresponding brace, to guide the paint spraying system to perform spraying operation of different parameters according to the wheel type.

Reading the brace means that, when the brace arrives at the tag read-write device, the tag read-write device reads the tag of the brace.

Selecting a spray room and a spray station means that the control system automatically selects a spray room and a spray station for spraying the hub with a paint according to the obtained hub feature information and the category of the colored paint at each spray station.

Calling spray parameters means, after reading the brace, reading corresponding data from the database of the control system to obtain feature information of the hub on the brace, and sending the feature information to the paint spraying system via a network, so that the robot and the multi-color paint supply system cooperate with each other to complete the paint spraying operation.

Spraying means that, after the hub enters the selected spray station, the hub rotates along with the brace under the drive of the rotating station, the multi-color paint supply system cooperates with the spraying robot according to the current hub spraying parameters called from the control system, and the spraying robot moves according to an action program, thus completing the paint spraying operation on the hub.

The flexible intelligent hub paint spraying line of the present disclosure has the advantages that: by combining the multi-color paint spraying system with intelligent recognition, simultaneous on-line spraying of multiple colored paint hubs is realized, decline of equipment efficiency due to replacement of the paint is avoided, and the problem of excessive in-process products caused by classified temporary stacking of hubs to be sprayed in the previous procedure is avoided. The present disclosure breaks through the traditional batch spraying mode, and adapts to current market demands for progressive small batch and customization.

### BRIEF DESCRIPTION OF THE DRAWINGS

FIG. 1 is a schematic diagram of equipment layout of an embodiment of the present disclosure.

In which: 1-conveying chain, 2-on-line area, 3-on-line robot, 4-transfer robot, 5-transfer area, 6-oven, 7-off-line area, 8-flash dry area, 9-spray room, 10-spraying robot, 11-spray area, 12-wheel type recognition system.

### DETAILED DESCRIPTION OF THE EMBODIMENTS

An example intelligent flexible hub paint spraying line will be further described in detail below in combination with an embodiment and the accompanying drawing.

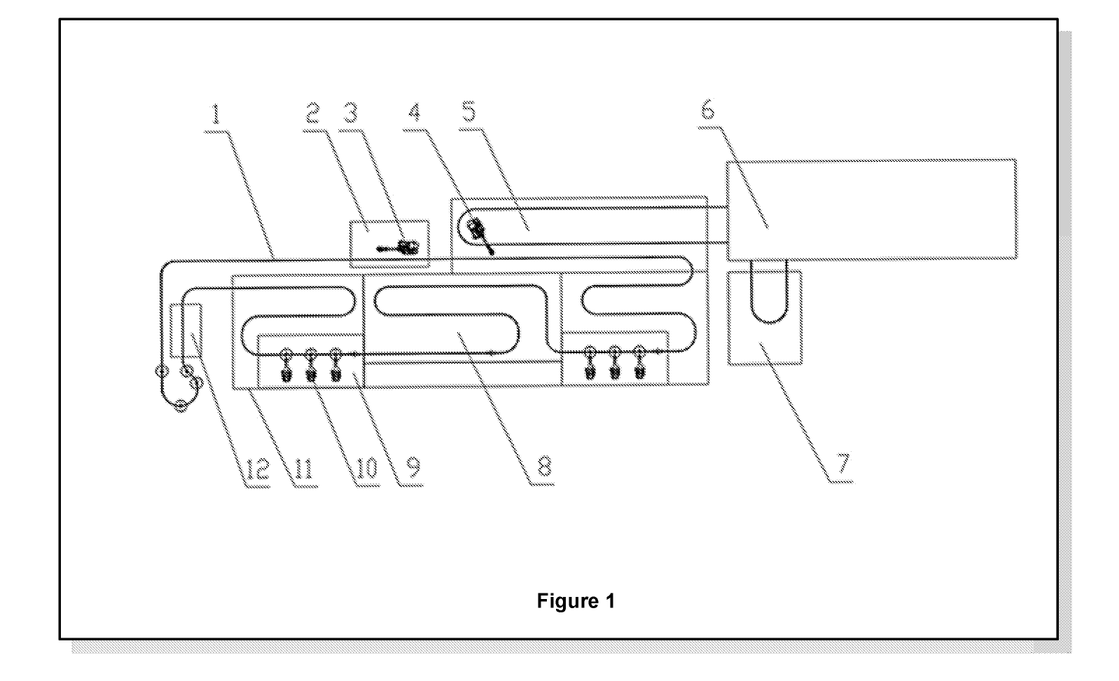

As shown in FIG. 1, a flexible intelligent hub paint spraying line includes a control system, a wheel type recognition system 12, a brace recognition system, a conveying chain 1, an on-line area 2, a spray area 11, a paint spraying system, a transfer area 5, an oven 6, an off-line area 7 and accessory equipment.

Two spray rooms 9 are serially arranged in the spray area 11, three spray stations are arranged in each spray room, a rotating station and a spraying robot 10 are arranged at each spray station, and the paint spraying system includes a spraying manipulator and a multi-color paint supply system.

The wheel type recognition system 12 is arranged in front of the inlet of the spray area 11 and connected with the control system by adopting weak current.

The conveying chain 1 includes a chain, braces and a driving mechanism, a read-write tag is arranged below each brace, the brace recognition system includes the read-write tags as well as tag read-write devices arranged at the wheel type recognition system 12 and the inlets of the spray rooms 9, and the tag read-write devices are connected with the control system through weak current.

The wheel type recognition system 12 adopts a visual recognition system, and performs recognition input on all wheel type image information before production and edits wheel type code information corresponding to images one by one.

The read-write tag is a radio frequency identification tag, and the corresponding read-write device is a radio frequency identification reader-writer.

A process flow for spraying a hub on the paint spraying line includes the steps of feeding a hub to be sprayed, recognizing the model of the hub, recognizing the brace, storing wheel type information, feeding the hub into the spray area, reading the brace, selecting a spray room and a spray station, calling spray parameters, spraying, completing spraying, leaving the spray room, transferring, baking and curing, and discharging the product.

1. A flexible intelligent hub paint spraying line, comprising a control system, a wheel type recognition system, a brace recognition system, a conveying chain, an on-line area, a spray area, a paint spraying system, a transfer area, an oven, an off-line area and accessory equipment, is characterized in that a plurality of spray rooms are serially arranged in the spray area, a plurality of spray stations are arranged in each spray room, a rotating station and a spraying robot are arranged at each spray station, and the paint spraying system comprises a spraying manipulator and a multi-color paint supply system; the wheel type recognition system is arranged in front of the inlet of the spray area and connected with the control system through weak current; the conveying chain comprises a chain, braces and a driving mechanism, a read-write tag is arranged below each brace, the brace recognition system comprises the read-write tags as well as tag read-write devices arranged at the wheel type recognition system and the inlets of the spray rooms, and the tag read-write devices are connected with the control system by adopting weak current.

2. The flexible intelligent hub paint spraying line of claim 1, wherein preferably, the wheel type recognition system adopts a visual recognition system.

3. The flexible intelligent hub paint spraying line of claim 1, wherein the wheel type recognition system may adopt a two-dimensional code recognition system, and comprises a two-dimensional code marked at the selected part of the inner cavity of each hub, and comprises a two-dimensional code scan gun arranged at the bottom.

4. The flexible intelligent hub paint spraying line of claim 1, wherein preferably, the read-write tag may adopt a radio frequency identification tag, and the corresponding read-write device is a radio frequency identification reader-writer.

5. The flexible intelligent hub paint spraying line of claim 1, wherein the read-write tag may adopt a two-dimensional code tag, and the corresponding read-write device is a dedicated scan reader-writer.

6. A flexible intelligent hub paint spraying process, comprising the steps of feeding a hub to be sprayed, recognizing the model of the hub, recognizing the brace, storing wheel type information, feeding the hub into the spray area, reading the brace, selecting a spray room and a spray station, calling spray parameters, spraying, completing spraying, leaving the spray room, transferring, baking and curing, and discharging the product; wherein
storing wheel type information means that, after the recognition system recognizes the model of the hub, successfully matched hub characteristic information is stored in a database of the control system according to the tag code of the corresponding brace, to guide the paint spraying system to perform spraying operation of different parameters according to the wheel type;
reading the brace means that, when the brace arrives at the tag read-write device, the tag read-write device reads the tag of the brace;
selecting a spray room and a spray station means that the control system automatically selects a spray room and a spray station for spraying the hub with a paint according to the obtained hub feature information and the category of the colored paint at each spray station;
calling spray parameters means, after reading the brace, reading corresponding data from the database of the control system to obtain feature information of the hub on the brace, and sending the feature information to the paint spraying system via a network, so that the robot and the multi-color paint supply system cooperate with each other to complete the paint spraying operation;
spraying means that, after the hub enters the selected spray station, the hub rotates along with the brace under the drive of the rotating station, the multi-color paint supply system cooperates with the spraying robot according to the current hub spraying parameters called from the control system, and the spraying robot moves according to an action program, thus completing the paint spraying operation on the hub.
